(19) United States
(12) Patent Application Publication
(10) Pub. No.: US 2007/0248025 A1
(43) Pub. Date: Oct. 25, 2007

(54) Apparatus, method and computer program product providing selection of packet segmentation

(75) Inventors: Vinh Van Phan, Oulu (FI); Tsuyoshi Kashima, Yokohama (JP); Kimmo Kettunen, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/705,632

(22) Filed: Feb. 13, 2007

Related U.S. Application Data
(60) Provisional application No. 60/773,211, filed on Feb. 13, 2006.

(51) Int. Cl. H04J 1/16

(52) U.S. Cl. 370/252; 370/338

(57) ABSTRACT

A method, computer program, and apparatus adaptively select a segmentation option for service data units based on a bandwidth allocation. In general terms, one of a first segmentation option or a second segmentation option is selected based on a bandwidth allocation that is selected from among several possible bandwidth allocation options. A service data unit is segmented according to the selected segmentation option and wirelessly transmitted. In an embodiment, the first segmentation option uses a predetermined length such as a fixed length that may be chosen to match an IP packet size, or a predetermined maximum length to which the size of segmented units are constrained, and segmentation occurs prior to packet scheduling. In an embodiment, the second segmentation option uses a dynamic length that changes per transmission time interval, and segmentation occurs after packet scheduling and after the size of the transport block is determined.

### CROSS-REFERENCE TO RELATED APPLICATIONS

This patent application claims priority under 35 U.S.C. §119(e) from U.S. Provisional Patent Application No. 60/773,211, filed on Feb. 13, 2006, the disclosure of which is incorporated by reference herein in its entirety. This application is related to the subject matter of U.S. Provisional Patent Application No. 60/773,208, filed on Feb. 13, 2006; U.S. Provisional Patent Application No. 60/773,402, filed on Feb. 14, 2006; and U.S. patent application Ser. No. 11/649,633, filed on Jan. 4, 2007.

### TECHNICAL FIELD

The exemplary and non-limiting embodiments of this invention relate generally to wireless communications systems, methods and devices and, more specifically, relate to techniques for operating a user equipment, such as a cellular phone, with a wireless network.

### BACKGROUND

The following abbreviations are herewith defined:
3GPP Third Generation Partnership Project
AMC Adaptive modulation and coding
BS base station
DCH dedicated transport channel
DL downlink (Node B to UE)
H-ARQ hybrid automatic request/acknowledge
HSPA high speed packet access
HSUPA high speed uplink packet access
IP internet protocol
L1 Layer 1 (Physical (PHY) Layer)
L2 Layer 2 (Link Layer)
LTE Long Term Evolution
MAC medium access control
Node B base station
OFDMA orthogonal frequency division multiple access
PDU protocol data unit
QoS quality of service
QPSK quadrature phase shift keying
EACH random access channel
RF radio frequency
PRC radio resource control
SC-FDMA single carrier-frequency division multiple access
SCH shared transport channel
SDU service data units
TB transport block
TTI transmission time interval
UE user equipment
UL uplink (UE to Node B)
UMTS Universal Mobile Telecommunications System
UTRA Universal Terrestrial Radio Access
UTRAN Universal Terrestrial Radio Access Network
E-UTRAN Evolved UTRAN
VolP voice over IP

Relevant to this disclosure is 3GPP TR 25.913, V7.2.0 (2005-12), Requirements for Evolved UTRA (E-UTRA) and Evolved UTRAN (E-UTRAN), attached to the above priority document as Exhibit A and thereby incorporated by reference herein as noted above.

Of particular interest to the exemplary embodiments of this invention are modern cellular networks, such as one referred to as UTRA LTE in 3GPP UMTS. Modern cellular networks may employ multi-carrier technologies such as OFDMA in the DL and SC-FDMA in the UL, and various advanced radio transmission techniques such as AMC and H-ARQ. The radio interface relies on the presence of a SCH in both the UL and DL with fast adaptive resource allocation for simple and efficient radio resource utilization and QoS support, and no longer uses a DCH. The spectrum flexibility requirement of E-UTRAN suggests that the system should be capable of operation in spectrum allocations of different sizes, including 1.25 MHz, 2.5 MHz, 5 MHz, 10 MHz, 15 MHz and 20 MHz, in both the UL and DL.

Details of this particular type of system may be found in 3GPP TR25.913, incorporated as noted above.

For the transmissions of data packets, in particular IP packets, over the radio interface, the link layer (L2) of the radio interface, including the MAC functionality, is responsible for segmenting IP-based SDUs passed down by an upper layer into one or several segments and, at the same time, packing one or multiple segments into a PDU for further physical layer (L1) transmission. These two processes, L2 SDU segmentation and L2 PDU packing, although seemingly contradictory and capable of generating significant protocol overhead, are both needed to ensure robust transmissions of IP packets with variable packet sizes in bits or bytes over erratic radio channels with variable bit rates.

Furthermore, L2 retransmissions using an ARQ protocol operating on a L2 SDU, or segments thereof, with a packet sequence number can be used, in addition to a HARQ at a lower level, to ensure a reliable, in-order L2 transmissions.

### SUMMARY

In accordance with one aspect of the invention is a method that includes determining a bandwidth allocation that is selected from among several possible bandwidth allocation options, and based on the determined bandwidth allocation, selecting one of a first segmentation option or a second segmentation option. Then, at least one service data unit is segmented according to the selected first segmentation option or second segmentation option, and the at least one segmented service data unit is transmitted within the determined bandwidth allocation.

In accordance with another aspect of the invention is a computer program embodied on a memory and executable by a processor for performing actions to adaptively segment service data units. In this aspect, the actions include determining a bandwidth allocation that is selected from among several possible bandwidth allocation options, and based on the determined bandwidth allocation, selecting one of a first segmentation option or a second segmentation option. At least one service data unit is segmented according to the selected first segmentation option or second segmentation option, and the at least one segmented service data unit is transmitted within the determined bandwidth allocation.

In accordance with another aspect is an apparatus that includes a processor coupled to a memory and a transmitter. The processor with the memory is adapted to determine a bandwidth allocation that is selected from among several possible bandwidth allocation options, and based on the detennined bandwidth allocation to select one of a first segmentation option or a second segmentation option, and further to segment at least one service data unit according to the selected first segmentation option or second segmentation option. The transmitter is adapted to transmit within the determined bandwidth allocation the at least one segmented service data unit.

In accordance with another aspect of the invention is an apparatus that includes means for selecting one of a first segmentation option or a second segmentation option based on the determined bandwidth allocation, and means for segmenting at least one service data unit according to the selected first segmentation option or second segmentation option, and further includes means for transmitting within the determined bandwidth allocation the at least one segmented service data unit. In a particular embodiment, the means for selecting and means for segmenting include a processor coupled to a computer program embodied on a memory, and the means for transmitting includes a transceiver.

These and other aspects are more fully detailed below.

### BRIEF DESCRIPTION OF THE DRAWINGS

In the attached Drawing Figures:

FIG. 1 shows a simplified block diagram of various electronic devices that are suitable for use in practicing the exemplary embodiments of this invention.

FIG. 2 depicts a logic flow diagram in accordance with an aspect of the exemplary embodiments of this invention.

FIG. 3 depicts a logic flow diagram in accordance with a further aspect of the exemplary embodiments of this invention.

FIG. 4 illustrates one suitable embodiment of basic data flow at the MAC layer.

### DETAILED DESCRIPTION:

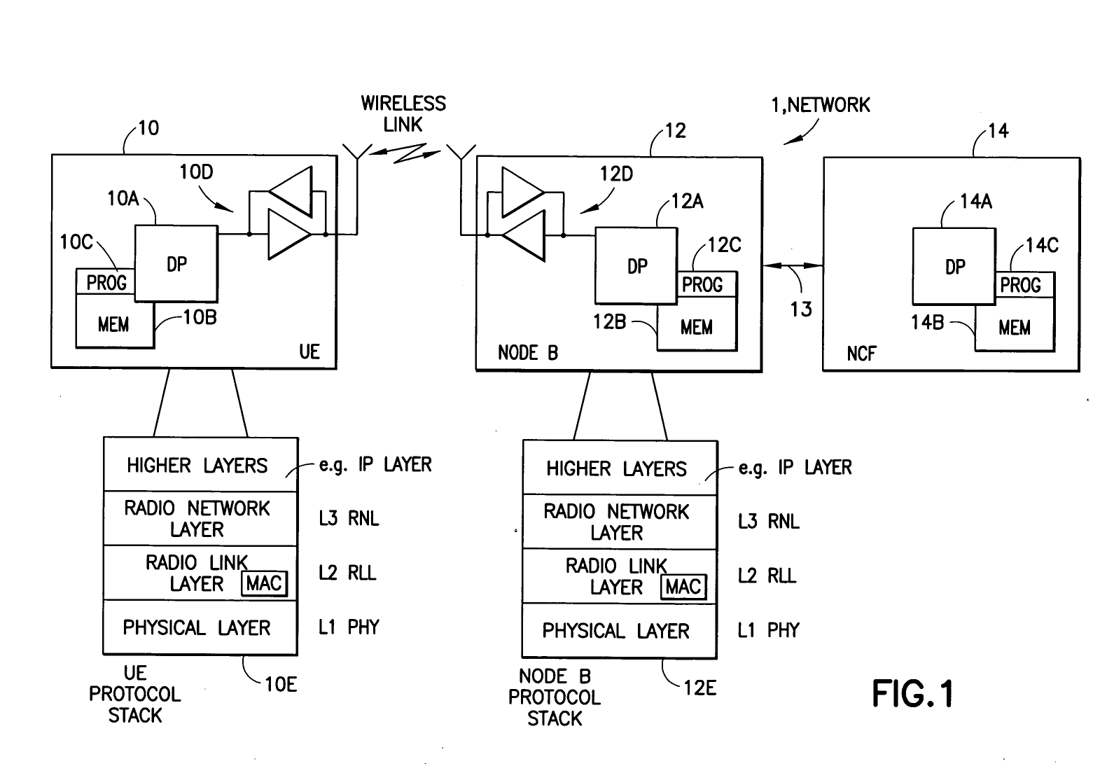

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via a Node B (base station) 12. The network 1 may include at least one network control function (NCF) 14. The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The Node B12 is coupled via a data path 13 to the NCF 14 that also includes a DP 14A and a MEM 14B storing an associated PROG 14C. At least one of the PROGs 10C and 12C is assumed to include program instructions that, when executed by the associated DP, enable the electronic device to operate in accordance with the exemplary embodiments of this invention, as will be discussed below in greater detail.

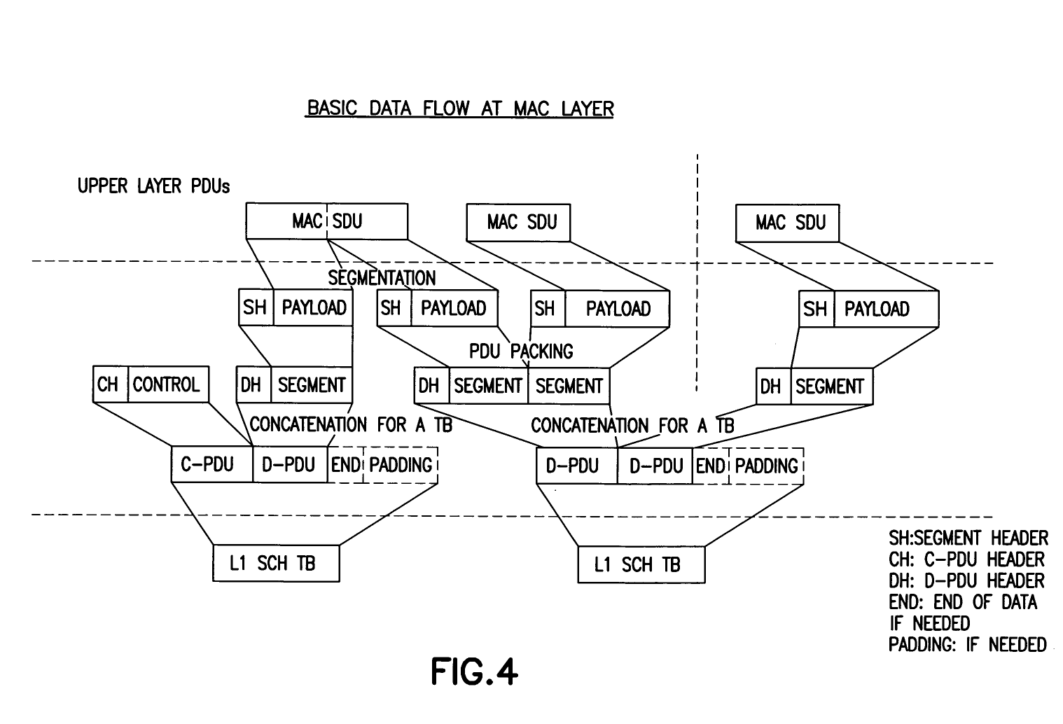

The UE 10 is assumed to include and implement a protocol stack 10E containing at least layers LI (PHY, Physical), L2 (RLL, Radio Link Layer, containing the MAC functionality) and L3 (RNL, Radio Network Layer), and typically higher layers as well (e.g., an IP layer). The Node B 12 is assumed to include and implement a protocol stack 12E also containing at least layers LI (PHY), L2 (RLL) and L3 (RNL), and typically also the higher layers as well (e.g., an IP layer). FIG. 4 illustrates one suitable and non-limiting embodiment of basic data flow at the MAC layer.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

Before discussing the exemplary embodiments of this invention, the following introductory description is presented.

In the current development of L2 concepts for E-UTRAN, several options for MAC protocol structures and functions, including segmentation and retransmission, may be considered. In general, these options differ in the area of SDU segmentation.

A first option follows a more or less similar approach as used in the current HSPA in UTRAN, wherein semi-static segmentation sizes for certain logical channels are used, and where segments may have a fixed size or a fixed size limit that is adjusted according to user-specific characteristics and averaged radio conditions. The size limitation implies a possible case in which only SDUs that have a size exceeding the size limit are segmented and, otherwise, a variable segment size is allowed.

One potential drawback to this approach is that the segmentation setting is preferably made somewhat conservative (the segment size is set to a small, conservative value) and, therefore, the performance in terms of protocol overhead and effective throughput can be reduced. A clear benefit to the use of this approach is that segmentation can be performed beforehand and independently from the packet scheduling and L1 operation. This reduces complexity and saves running time for other related processes that need to be executed within the required TTI.

A second option proposes a dynamic, on-the-fly segmentation per TTI. In this approach any required segmentation is performed after the scheduling decision is made, and the available TB size has been determined.

A potential drawback to the use of this approach is the more stringent processing time budget for required L1-L2 operations within a TTI. A benefit of this approach is that the segmentation can be optimized for the available TB size, thereby minimizing protocol overhead and the processing load of performing unnecessary segmentation operations.

A consideration is now made of several comparative examples that will serve to place into context the benefits of the use of the exemplary embodiments of this invention. The current HSPA of UTRAN is used as the reference due to the fact that E-UTRAN system requirements, described in TR25.913, also use UTRAN HSPA as the main reference. In general, however, the exemplary embodiments of this invention do not rely on the presence or use of UTRAN HSPA.

UTRAN HSPA employs, in a general sense, the first option discussed above. It is noted in this regard that the minimum TTI in the current HSPA of UTRAN is 2 ms, whereas in E-UTRAN the TTI is proposed to be 0.5 ms or 1.0 ms. This means that, assuming the same available TB size, the scheduled data rate in E-UTRAN should be about four times greater than that of HSPA. The potential gain of the second option, in terms of reducing protocol overhead, is more notable if the available TB size in E-UTRAN is made larger than that of the HSPA counterpart, that is, the scheduled data rate for a user at any given time can be greater than about four times of HSPA. This is foreseeable only when the system bandwidth available for E-UTRAN operation is at least the same as for UTRAN, i.e., 5 MHz, as E-UTRAN has a higher spectrum efficiency requirement.

Considering now additional numerical examples, consider a case of E-UTRAN where the scheduled data rate for a TTI is about 2Mbps (million bits per second). Thus, the TB size is about 1000 bits (assuming a TTI=0.5 ms), which is not much greater than what can be set for the MAC PDU size of the DCH transmitted over HS-DSCH. In this case, the gain derived from the use of the second option is not particularly significant. In another case, E-UTRAN operates in a 1.25 MHz system bandwidth with 1/2 coding rate and QPSK modulation. In this case there are only 450 information bits available for a TTI of one sub-frame duration (assuming 0.5 ms). A typical large IP packet has a length of about 1500 bytes=12000 bits, and such an IP packet will need to be segmented into at least 25 MAC segments. In these exemplary examples, and depending on the platform capabilities, it can be seen that the first option, with semi-static segmentation size setting, can be more feasible and practical to implement.

It can be noted that, in addition to the two options described above, the optimization of TB size for given user traffic characteristics (e.g., MAC SDU sizes, arrival and serving patterns, etc.) may result in similar efficiency gains related to system performance. However, this is generally considered to be an element of optimized packet-scheduling design, which has a larger scope and requires much more processing and complexity than the problems addressed and the solutions provided by the exemplary embodiments of this invention.

Hence, considering the various tradeoffs between simplicity and efficiency that are considered by the two options discussed above, the exemplary embodiments of invention provide an ability to make selective use, in an informed manner, of these options as they relate to L2 packet segmentation and retransmission. An aspect of the use of the exemplary embodiments of this invention is an adaptation to the configurable and flexible spectral bandwidth of the system.

It should be noted that the MAC PDU structures can be designed for each of the above options, and in such a way that allows for both the above options to be used without any modification.

In accordance with the exemplary embodiments of this invention the spectral bandwidth of the system is constrained to the spectrum flexibility requirement as currently specified in the incorporated document 3GPP TR25.913 Section 8.2, which currently includes: a) support for spectrum allocations of different sizes such as 1.25 MHz, 2.5 MHz, 5 MHz, 10 MHz, 15 MHz and 20 MHz in both the UL and the DL; and b) support for diverse spectrum arrangements.

More specifically, 3GPP TR25.913 Section 8.2, Spectrum Flexibility currently states:

a) Support for spectrum allocations of different size
1) E-UTRA shall operate in spectrum allocations of different sizes, including 1.25 MHz, 2.5 MHz, 5 MHz, 10 MHz, 15 MHz and 20 MHz. in both the uplink and downlink. Operation in paired and unpaired spectrum shall be supported.
2) Unnecessary fragmentation of technologies for paired and unpaired band operation shall be avoided. This shall be achieved with minimal additional complexity.

b) Support for diverse spectrum arrangements
1) The system shall be able to support (same and different) content delivery over an aggregation of resources including Radio Band Resources (as well as power, adaptive scheduling, etc) in the same and different bands, in both uplink and downlink and in both adjacent and non-adjacent channel arrangements.
2) The degree to which the above requirement is supported is conditioned on the increase in UE and network complexity and cost.
3) A “Radio Band Resource” is defined as all spectrum available to an operator.

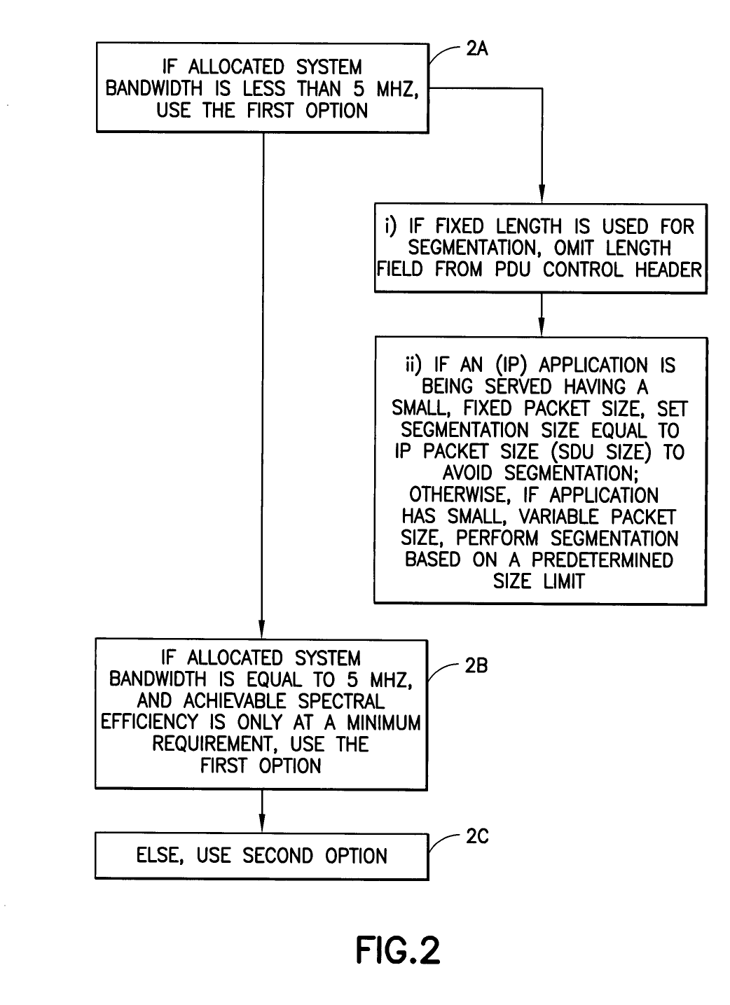

In accordance with the exemplary embodiments of this invention, and depending on the system bandwidth allocation and the achievable spectral efficiency, either the first option or the second option discussed above are adopted for use. For example, and referring to the logic flow diagram of FIG. 2:

Block 2A. If the allocated system bandwidth is less than 5 MHz, use the first option;
i. in a case where a fixed length is used for segmentation, a length field is omitted from a control header (CH) of PDUs;
ii. in a case of where IP-based applications, such as VoIP, are being served, i.e., those having fixed and relatively small packet sizes, the segmentation size is set to be the same IP packet size (SDU size) thereby avoiding actual segmentation; otherwise, when IP applications have relatively small, but variable, packet sizes, the segmentation is performed using the pre-determined segment size. The segment size can be semi-statically controlled and optimized by the control function based on the application characteristics.

Block 2B. If the allocated system bandwidth is equal to 5 MHz, and the achievable spectral efficiency is only a minimum requirement, that is, about two times greater than that of HSPA in UTRAN, use the first option.

Block 2C. Otherwise, use the second option.

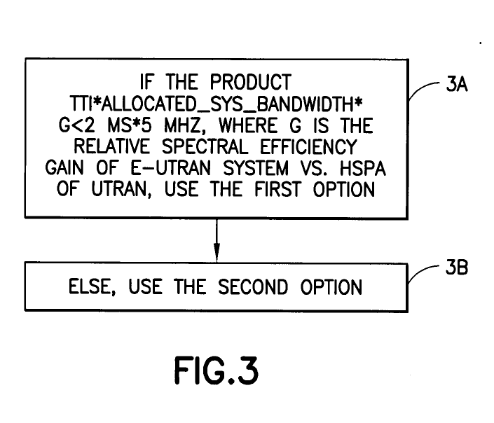

In addition, for a case that considers more generic system conditions such as that the system allows more a flexible length of the TTI as an interleaving interval of a TB (note that the above discussion has assumed a rather short TTI of about half of a millisecond), or that the system spectral efficiency need not be exactly four times greater than HSPA, the criteria for choosing segmentation options may be, as non-limiting examples, as follows (see FIG. 3):

Block 3A. If the product TTI*Allocated_System_Bandwidth*G is less than 2 ms*5 MHz, where G is the relative spectral-efficiency gain of the E-UTRAN system vs. HSPA of UTRAN taking a value between two and four as required in 3GPP TR25.913, use the first option;

Block 3B. Else, use the second option.

To further reduce complexity, while still maintaining adequate efficiency when possible, the exemplary embodiments of this invention also provide for the possibility of omitting segmentation altogether when the scheduled bandwidth exceeds 10 MHz or, more generally, when the scheduled TB size is foreseen as being much larger than the maximum SDU size. Note in this regard that the TB size in E-UTRAN can be up to tens of thousand bits and, typically, the IP-based maximum SDU size is about 12,000 bits.

The exemplary embodiments of this invention also provide for the possibility of making optional the use of the length indicating field and the position-offset indicating field that are included in the control header of a MAC SDU segment (which are needed for segmentation control and operation). These can be omitted in the case that the first option with a fixed segment size is selected, but also considering whether it is the first, intermediate or last segment of a SDU and/or padding is needed. The fixed segment size, in that case, is assumed to be signaled between the transmitter and the receiver beforehand. The sequence number field in the segment header needed for segmentation control and ARQ operation, in the first option with pre-segmentation, may also be mutually understood by the transmitter and the receiver as a segment sequence number (otherwise defined as the SDU sequence number).

The use of the exemplary embodiments of this invention may employ signaling of certain L2 configuration parameters (e.g., information concerning SDU size, segmentation size, and/or the segmentation size limit), and the receipt and interpretation of certain cell configuration parameters at the UE 10 via, e.g., broadcast system information such as, but not limited to, operating system bandwidth(s).

Additional details regarding the signaling of information and data structures related to the MAC SDUs in E-UTRAN systems to support the aforementioned exemplary embodiments of this invention may be found in a commonly owned U.S. Provisional Patent Application 60/773,208, filed on Feb. 13, 2006, entitled “Apparatus, Method and Computer Program Product Providing Simple and Effective In-Band Signaling and Data Structures for Adaptive Control and Operation of MAC in E-UTRAN Systems”, by Vinh Van Phan, Tsuyoshi Kashima, Kimmo Kettunen and Jukka Ranta.

The exemplary embodiments of this invention allow for a most efficient hardware and software implementation of the advanced features for E-UTRAN, and also provide a selection mechanism that is amenable to standardization in regard to L2 segmentation and data structure design.

Note further that the use of the exemplary embodiments of this invention do not require any significant changes in existing structures and procedures of the radio interface and, in particular, of L2.

As should be apparent at this point, disclosed above are a number of practical techniques for adaptive MAC packet segmentation and transmission depending, for example, on the size of the allocated system bandwidth in MHz, TTI and spectrum efficiency. This is subject to an optimal trade-off between simplicity and efficiency in system design and performance. The disclosed techniques include the pre-segmentation approach, in which all the segmentation is done beforehand and independently from the packet scheduling and L1 operation in a semi-static fashion, and the post-segmentation approach, in which the segmentation is done per TTI on a necessity basis optimized for an allowed TB size. The allowed TB size is preferably large and determined after the scheduling and allocation decision is made for the current TTI.

Viewed in another way, the adaptive operation of MAC, in particular MAC segmentation functions, may be optimized for a certain type of traffic, application or service such as VolP. This type of traffic typically exhibits a small, fixed or variable, packet size and in general should preferably not be MAC segmented for achieving efficient transmission over the radio interface SCH. This particular case can be referred to as the non-segmentation approach.

Note that the exemplary embodiments of this invention can be used in the DL and in the UL.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerfiil software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

We claim:

1. A method comprising:
determining a bandwidth allocation that is selected from among several possible bandwidth allocation options;
based on the determined bandwidth allocation, selecting one of a first segmentation option or a second segmentation option;
segmenting at least one service data unit according to the selected first segmentation option or second segmentation option; and
transmitting within the determined bandwidth allocation the at least one segmented service data unit.

2. The method of claim 1, wherein the several possible bandwidth allocation options are selected from the group 1.25 MHz, 2.5 MHz, 5 MHz, 10 MHz, 15 MHz, and 20 MHz.

3. The method of claim 1, wherein selecting one of the first segmentation option or the second segmentation option is based on a size of the determined bandwidth allocation.

4. The method of claim 3, wherein the first segmentation option comprises segmenting prior to and independent of packet scheduling for the transmitting; and wherein the second segmentation option comprises segmenting after packet scheduling for the transmission and after a transport block size is determined.

5. The method of claim 1, wherein the first segmentation option comprises a predetermined length; and wherein the second segmentation option comprises a dynamic length that changes per transmission time interval.

6. The method of claim 5, further comprising packing the at least one segmented service data unit into a protocol data unit, and wherein transmitting the at least one segmented service data unit comprises transmitting the protocol data unit, wherein for the case where the first segmentation option is selected a length field is omitted from the protocol data unit and for the case where the second segmentation option is selected the length field is included in the protocol data unit.

7. The method of claim 5 wherein the predetermined length is the same as a size of an internet protocol packet.

8. The method of claim 5, wherein the predetermined length comprises a maximum length and the service data unit is constrained not to exceed the maximum length.

9. The method of claim 1, wherein determining a bandwidth allocation comprises determining the bandwidth allocation size and a spectral efficiency;
and wherein selecting one of the first segmentation option or the second segmentation option is based on the determined bandwidth allocation size and the spectral efficiency.

10. The method of claim 9, wherein the second segmentation option comprises segmenting to a length defined per transmission time interval TTI, and wherein selecting is based on a function of TTI, bandwidth allocation size, and relative spectral efficiency.

11. The method of claim 10, wherein the function is TTI*bandwidth allocation size*G, wherein G is the relative spectral efficiency gain of E-UTRAN as compared to high speed packet access of UTRAN that takes a value between two and four, and wherein the first option is selected when:
TTI*bandwidth allocation size*G<2 msec*5 MHz.

12. A computer program embodied on a memory and executable by a processor for performing actions to adaptively segment service data units, the actions comprising:
determining a bandwidth allocation that is selected from among several possible bandwidth allocation options;
based on the determined bandwidth allocation, selecting one of a first segmentation option or a second segmentation option;
segmenting at least one service data unit according to the selected first segmentation option or second segmentation option; and
transmitting within the determined bandwidth allocation the at least one segmented service data unit.

13. The computer program of claim 12, wherein selecting one of the first segmentation option or the second segmentation option is based on a size of the determined bandwidth allocation.

14. The computer program of claim 13, wherein the first segmentation option comprises segmenting prior to and independent of packet scheduling for the transmitting; and wherein the second segmentation option comprises segmenting after packet scheduling for the transmission and after a transport block size is determined.

15. The computer program of claim 12, wherein the first segmentation option comprises a predetermined length; and wherein the second segmentation option comprises a dynamic length that changes per transmission time interval.

16. The computer program of claim 15, the actions further comprising packing the at least one segmented service data unit into a protocol data unit, and wherein transmitting the at least one segmented service data unit comprises transmitting the protocol data unit, wherein for the case where the first segmentation option is selected a length field is omitted from the protocol data unit and for the case where the second segmentation option is selected the length field is included in the protocol data unit.

17. The computer program of claim 15 wherein the predetermined length is the same as a size of an internet protocol packet.

18. The computer program of claim 15, wherein the predetermined length comprises a maximum length and the service data unit is constrained not to exceed the maximum length.

19. The computer program of claim 12, wherein determining a bandwidth allocation comprises determining the bandwidth allocation size and a spectral efficiency;
and wherein selecting one of the first segmentation option or the second segmentation option is based on the determined bandwidth allocation size and the spectral efficiency.

20. The computer program of claim 19, wherein the second segmentation option comprises segmenting to a length defined per transmission time interval TTI, and wherein selecting is based on a function of TTI, bandwidth allocation size, and relative spectral efficiency.

21. The computer program of claim 20, wherein the function is TTI*bandwidth allocation size*G, wherein G is the relative spectral efficiency gain of E-UTRAN as compared to high speed packet access of UTRAN that takes a value between two and four, and wherein the first option is selected when:
TTI*bandwidth allocation size*G<2 msec*5 MHz.

22. An apparatus comprising:
a processor coupled to a memory and adapted to determine a bandwidth allocation that is selected from among several possible bandwidth allocation options, and based on the determined bandwidth allocation to select one of a first segmentation option or a second segmentation option, and to segment at least one service data unit according to the selected first segmentation option or second segmentation option; and
a transmitter coupled to the processor and adapted to transmit within the determined bandwidth allocation the at least one segmented service data unit.

23. The apparatus of claim 22, wherein the processor is adapted to select one of the first segmentation option or the second segmentation option based on a size of the determined bandwidth allocation.

24. The apparatus of claim 23, wherein the first segmentation option comprises segmenting prior to and independent of packet scheduling for transmitting the at least one service data unit; and wherein the second segmentation option comprises segmenting after packet scheduling for transmitting the at least one service data unit and after a transport block size is determined.

25. The apparatus of claim 22, wherein the first segmentation option comprises a predetermined length; and wherein the second segmentation option comprises a dynamic length that changes per transmission time interval.

26. The apparatus of claim 22, wherein the determined bandwidth allocation comprises bandwidth allocation size and spectral efficiency;
and wherein the processor is adapted to select one of the first segmentation option or the second segmentation option based on the determined bandwidth allocation size and the spectral efficiency.

27. The apparatus of claim 26, wherein the second segmentation option comprises segmenting to a length defined per transmission time interval TTI, and wherein the processor is adapted to select based on a function of TTI, bandwidth allocation size, and relative spectral efficiency.

28. The apparatus of claim 27, wherein the function is TTI*bandwidth allocation size*G, wherein G is the relative spectral efficiency gain of E-UTRAN as compared to high speed packet access of UTRAN that takes a value between two and four, and wherein the first option is selected when:
TTI*bandwidth allocation size*G<2 msec*5 MHz.

29. An apparatus comprising:
means for selecting one of a first segmentation option or a second segmentation option based on the determined bandwidth allocation;
means for segmenting at least one service data unit according to the selected first segmentation option or second segmentation option; and
means for transmitting within the determined bandwidth allocation the at least one segmented service data unit.

30. The apparatus of claim 29, wherein
the means for selecting and means for segmenting comprise a processor coupled to a computer program embodied on a memory; and
the means for transmitting comprises a transceiver.
